(19) United States
(12) Patent Application Publication
(10) Pub. No.: US 2008/0090736 A1
(43) Pub. Date: Apr. 17, 2008

(54) USING KNOWLEDGE PATTERN SEARCH AND LEARNING FOR SELECTING MICROORGANISMS

(75) Inventors: YING ZHAO, Cupertino, CA (US); Charles Chuxin Zhou, Cupertino, CA (US); Hsiu-Ying Wei Sherry, San Jose, CA (US)

Correspondence Address: CHARLES C. ZHOU, SUITE 100, 3375 SCOTT BLVD, SANTA CLARA, CA, 95054, US

(73) Assignee: QUANTUM INTELLIGENCE, INC., SANTA CLARA, CA (US)

(21) Appl. No.: 11/949,049

(22) Filed: Dec. 3, 2007

Related U.S. Application Data
(60) Provisional application No. 60/935,159, filed on Jul. 27, 2007.
(60) Provisional application No. 60/964,207, filed on Aug. 10, 2007.

(51) Int. Cl. C40B 30/02

(52) U.S. Cl. 506/8; 435/29

(57) ABSTRACT

This invention is to use knowledge pattern learning and search system for selecting microorganisms to produce useful materials and to generate clean energy from wastes, wastewaters, biomass or from other inexpensive sources. The method starts with an in silico screening platform which involves multiple steps. First, the organisms' profiles are compiled by linking the massive genetic and chemical fingerprints in the metabolic and energy-generating biological pathways (e.g. codon usages, gene distributions in function categories, etc.) to the organisms' biological behaviors. Second, a machine learning and pattern recognition system is used to group the organism population into characteristic groups based on the profiles. Lastly, one or a group of microorganisms are selected based on profile match scores calculated from a defined metabolic efficiency measure, which, in term, is a prediction of a desired capability in real life based on an organism's profile. In the example of recovering clean energy from treating wastewaters from food process industries, domestic or municipal wastes, animal or meat-packing wastes, microorganisms' metabolic capabilities to digest organic matter and generate clean energy are assessed using the invention, and the most effective organisms in terms of waste reduction and energy generation are selected based on the content of a biowaste input and a desired clean energy output. By selecting a microorganism or consortia of multiply microorganisms using this method, one can clean the water and also directly generate electricity from Microbial Fuel Cells (MFC), or hydrogen, methane or other biogases from microorganism fermentation. In addition, using similar screening method, clean hydrogen can be recovered first from an anaerobic fermentation process accompanying the wastewater treatment, and the end products from the fermentation process can be fed into a Microbial Fuel Cell (MFC) process to generate clean electricity and at the same time treat the wastewater. The invention can be used to first select the hydrogenic microorganisms to efficiently generate hydrogen and to select electrogenic organisms to convert the wastes into electricity. This method can be used for converting wastes to one or more forms of renewable energies.

### CROSS-REFERENCE TO RELATED APPLICATIONS

The benefit of provisional patent application No. 60/935,159, filed Jul. 27, 2007, and provisional patent Application No. 60/964,207 filed Aug. 10, 2007 under 35 U.S.C. 119(e), are hereby claimed.

### FEDERALLY SPONSORED RESEARCH

The invention was supported in part by US Army Small Business Innovation Research contract No. CBD W911NF-06-C-0056 and contract No. W911NF-07-C-0039 with Chemical Biological Defense (CBD) of US Army Research Office

### SEQUENCE LISTING

NONE

### REFERENCES

1. “2002 Review by the State Water Resources Control Board (SWRCB) of California” 2002. (http://www.swrcb.ca.gov/ab885/technosite.html)

2. Logan, B. E., Regan, J. M. Electricity-producing bacterial communities in microbial fuel cells. Trends Microbiol. 2006 December; 14(12):512-8. Review.

3. Lovley, D. R. Microbial fuel cells: novel microbial physiologies and engineering approaches. Curr Opin Biotechnol. 2006 June; 17(3):327-32. Review.

4. Oh, S. E., Logan, B. E. Hydrogen and electricity production from a food processing wastewater using fermentation and microbial fuel cell technologies. Water Res. 2005 November; 39(19):4673-82.

### FIELD OF THE INVENTION

This invention relates generally to metabolic reaction networks, and more specifically to finding and customizing efficient microorganisms to metabolize bio-wastes in wastewaters or in other forms of wastes, extract desired clean energy and at the same time to produce clean water or other useful materials

### BACKGROUND OF THE INVENTION

Civilizations have historically flourished around major water systems, metropolises own their success to the accessibility of water. Water is one of the most vitally necessary yet frequently overlooked resources necessary for our survival. Due to the higher prevalence of human impacts on the environment, water pollution has become an increasingly significant problem. The wastewater generated by anthropogenic influences need to be processed daily to ensure clean water consumption.

The biological treatments of wastewater (e.g. trickling bio-filter, activated sludge process, suspended growth treatment systems) are among the oldest and most well characterized technologies. Currently, industrial wastewater is typically treated by aerobic systems that remove contaminants prior to discharging the water to river, lake or undergroung. Although the aerobic system is effective at cleaning waters, a major drawback is that these treatment systems require large amounts of electricity for proper operation. Annual power usage of a single residential system is in the range of 750 to 1500 kWh. [ref 1, 2002] Aerobic systems also require continuous air supply which adds substantial maintenance cost for long term operation. The current wastewater treatment plants in U.S. used 5% of national electricity to do wastewater treatment, which is equivalent to about $10 billion dollars.

Another disadvantage of the aerobic system is the production of large amounts of sludge. In current wastewater treatment process, after aeration by the aerobic bacteria, sludge is generated in the form of wastewater residues and requires additional processing. Commonly this sludge is shipped to landfills to decompose, which raises additional environmental pollution concerns. Additionally, the aerobic process reduces the dissolved oxygen in the wastewater which is detrimental to fish and other aquatic life. Thus, there is an urgent need to develop economically feasible new technologies.

New processes such as anaerobic systems, which are characterized by the absence of free oxygen from the treatment process and typically used for the treatment of waste that has a high concentration of biodegradable organic material, are developed. The anaerobic respiration process produces hydrogen, methane, and carbon dioxide, which are further used to provide energy services, and requires much less electricity than the aerobic system. The annual power usage of a single residential system is in the range of 50 to 100 kWh (7% of aerobic system) and requires no air supply [ref 1]. Another advantage of anaerobic systems is that they do not require subsequent soil distribution system and are therefore more adaptable to sites that have restrictions for other types of treatment systems, such as areas with high groundwater. Additionally, the residual semi-solid material left from the wastewater treatment processes (sludge) produced in an anaerobic system is far less than that produced by comparable aerobic systems. Perhaps the biggest advantage of an anaerobic system is its ability to generate clean energy with minimal energy consumption during the water treatment process. By using anaerobic microorganisms and their inherent fermentation pathways, hydrogen and methane gases can be directly harvested and converted to usable energy.

However, although methane production via anaerobic digestion is a mature process that has been most commonly used within full-scale facilities so far, it has some major drawbacks as well. For examples, most wastewater is too dilute to be treated using this technology to produce methane efficiently; it cannot operate at the normal temperature and requires heat for operation; it needs gas treatment and methane collection facilities; it needs “heat to electricity generation” facilities, such as a gas turbine generator.

More recently, the microbial fuel cell (MFC) technology has emerged as a novel approach to harvest energy from dissolved biomass. MFCs are devices that generate current by using bacteria as the catalysts to oxidize organic or inorganic substances. Electrons produced by the bacteria from these substrates can be transferred to the anode (negative terminal), and then flow to the cathode (positive terminal) through a conductive material containing a resistor which links the anode and cathode. There are several ways to transfer electrons to the anode, such as by electron mediators or shuttles; by direct membrane associated electron transfer; by nanowires produced by the bacteria, etc. If no exogenous mediators are added to the system, the MFC is classified as a “mediator-less” MFC[ref 2].

One application of MFC is to convert organic matters in wastewater to electricity using electrogenic bacteria. The organic matter can be from the original wastewaters or the leftover matter such as acetate, butyrate, and lactate after 15% hydrogen is generated.

MFC possesses several advantages over anaerobic digestion such as: it can produce electricity directly from organic waste without the need for gas treatment; it can convert energy at temperatures below 20° C. and at low substrate concentration levels, where the processes can not be performed using anaerobic digestion [ref 3]. Historically, MFCs do not produce much electricity economically. In last 10 years, however, power density from MFC has rapidly increased by optimizing the MFC equipment and by choosing smart microbes. While the architecture of MFC has been improved significantly to reduce construction and operating costs, and to increase power densities over the years, the microbiology of MFC biofilms and the effects of the ecology on MFC performance have not yet been explored thoroughly. The high diversity of metabolic capabilities the microorganisms is promising to the harvesting of the remaining renewable energy.

Numerous bacteria which can respire anaerobically are capable of using macroscopic electrodes as electron acceptors. MFCs are operated using these bacteria either through pure cultures or mixed cultures. Shewanella putrefaciens, Pseudomonas aeruginosa, Geobacter sp., Rhodoferax ferrireducens are revealed to be used in pure-culture-operated MFCs from several srudies. Thermophilic bacteria, such as Bacillus licheniformis or Bacillus thermoglucosidasius are also reported to be used when MFCs are operated at high temperature. In mixed-culture-operated MFC, its performance is determined by the interaction of the whole microbial community, namely “electrochemically active consortium”. The sources of the mixed cultures are either from sediment (both marine and lake sediment) or activated sludge from wastewater treatment plants. Analysis of the “electrochemically active consortia” revealed that Geobacter sp., Desulfuromonas sp., Alcaligenes faecalis, Enterococcus faecium, Pseudomonas aeruginosa, Clostridium sp., Bacteroides sp., Aeromonas sp. and Brevibacillus sp. are detected in the mixed cultures. The mixed-cultured MFCs have shown to produce more power than those with pure cultures, possibly due to the following properties the consortia possess: a higher resistance against process disturbances; a greater substrate versatility, and a higher power output[ref 2, 3, 4].

Considering all above, the most promising and economical method of MFC optimization is to find efficient microbes to metabolize biomass. Several approaches have been used to select or construct the efficient electrogenic organisms.

Study and Improve Current Electrogenic Organisms

One approach is to study the mechanisms of electron transfer between the currently known electrogenic organisms and the electrode. The ultimate goal is to optimize MFC performance either through better electrode design, or genetic engineering microbes to be efficient electricity producers. Geobacter and Rhodoferax (e.g. Rhodoferax ferrireducens) species, have the novel ability to directly transfer electrons to the surface of electrodes, which makes it possible to harvest electricity from waste organic matter. The energy metabolism under a variety of nutrient conditions of other representative electrogenic microbes such as Geobacter metallireducen, Shewanella oneidensis have also been investigated.

While a thorough understanding of the mechanisms behind the MFC technology is important, this approach only confined to a small set of organisms, and many more electrogenic microbes are left untapped or undiscovered. Besides, this approach is only focus on single bacteria strain, whereas mix-cultured consortia have been shown to be more efficient in MFC.

Experimentally Select and Enrich Organisms from Respective Wastewater Surrounding Environment

Another approach employed by most MFC labs is to experimentally select and enrich organisms in the anaerobic sewage sludge obtained from the surrounding area of the respective wastewater treatment plants. Anaerobic sewage sludge is usually a good source for inoculating a MFC due to its easy accessibility and rich content of varied bacterial communities that include electrochemically active bacteria, and other non-electrogenic microbes such as fermentative bacteria, methanogens, and sulfate reducers. However, the electrochemically active bacteria have been estimated to only comprise a small percentage of the total bacteria in activated sludge typically. Several rounds of enrichment process to increase the population of electrogenic microbes are usually necessary to reach satisfactory MFC performance. While this approach can obtain organisms which fit to the environment of the respective wastewater plants best, thus enrich the bacterial communities that digest the particular kind of wastewater most efficiently, the process is tedious and time-consuming, and unavoidable for all the different kind of wastewaters need to be treated.

Other than the bacteria mentioned above, there should be more new types of bacteria that are capable of anodophilic electron transfer (electron transfer to an anode) yet to be discovered[ref 2], and this is the area where this invention can help.

Systematically Selecting Organisms in Respect to Different Wastewaters Using an In Silico Screening Platform “Computer-Assisted Strain Construction and Development Engineering (CASCADE)”

The approach utilized this invention is to systematically select organisms in respect to different wastewaters using an In Silico screening platform “Computer-Assisted Strain Construction and Development Engineering (CASCADE)”, which is developed under a SBIR Phase II contract from the US Army, and an extension of an earlier system QIS D² (Quantum Intelligence System for Drug Discovery) developed from DARPA SBIR Phase II Award (May 2004-May 2006): Development of Predictive Algorithms for In Silico Drug Toxicity and Efficacy Assessment. This project focuses on developing predictive algorithms for accurately predicting drug toxicity and efficacy from multiple data sources. A QIS D² model can be successfully trained, tested and validated on evidence data sets (either experimental or logical) for predicting the potential in vitro or in vivo effects of drug molecules in biological systems, of particular interest are effects arising from chemical and biological agents and pathogens. QIS D² system possesses the core capabilities of modeling the data from various sources, including data and text, and integrating them for drug discovery; of performing sensitivity analysis for biochemical targets of interest, of accurately predicting biochemical targets of interest using a large number of attributes. It is able to predict thousands of targets simultaneously. Likewise, the QIS D² methodology has been applied in CASCADE development to understand why organisms are metabolically different based on their generic makeup.

By applying CASCADE, this invention is able to link massive genetic and chemical fingerprints in the metabolic and energy-generating biological pathways to assess an organism's metabolic capability to digest the organic matters, generate hydrogen, and electricity, at the same time to clean the wastewater. This makes it possible to customize and find efficient microbes (—or even to discover novel microorganisms) for hydrogen production, electricity generation and BOD (Biological Oxygen Demand) reduction based on the initial content of a wastewater, therefore it will drastically increase the conversion rates of both hydrogen and electricity productions.

The CASCADE platform can also apply to the applications in biological methane and chemical production during wastewater treatment. As shown in FIG. 4, which depicts the hydrogen and electricity production from renewable organic wastes using fermentation and MFC technologies, a mixture of bacteria is selected by CASCADE to optimize the hydrogen and electricity production. Likewise, the electrogenic organisms can be replaced by methanogens in the methane production application, or the suitable microbes for bioconversion in the chemical production process depending on the content of the wastewaters. Here, CASCADE can be used to select the optimal bacteria consortia to maximize the yields of the desired products.

### SUMMARY OF THE INVENTION

This invention is a knowledge pattern learning and search system for selecting microorganisms to generate clean energy. The method is an in silico screening platform which involves three steps. First, the organisms' profiles are compiled by linking the massive genetic and chemical fingerprints in the metabolic and energy-generating biological pathways (e.g. codon usages, gene distributions in function categories, etc.) to the organisms' biological behaviors. Second, a machine learning and pattern recognition system is used to group the organism population into characteristic groups based on the profiles. Lastly, one or a group of microorganisms are selected based on profile match scores calculated from a defined metabolic efficiency measure, which, in term, is a prediction of a desired capability in real life based on an organism's profile. In the example of recovering clean energy from treating wastewaters from food process industries, domestic, animal or meat-packing wastes, microorganisms' metabolic capabilities to digest a required organic matter and generate clean energy are assessed using the invention, and the most effective organisms in terms of waste reduction and energy generation are selected based on the content of a biowaste input and a desired clean energy output. Thus, using a microorganism or consortia, clean hydrogen can be recovered from an anaerobic fermentation process accompanying the wastewater treatment, and the end products from the fermentation process can be fed into a Microbial Fuel Cell (MFC) process to generate clean electricity and at the same time treat the wastewater. The invention can be used to first select the microorganisms to efficiently generate hydrogen and select electrogenic organisms to convert the by-products into electricity.

The original goal of the invention is to recover clean energy from biowastes. Clean energy here refers to the renewable energy which has the maximum efficiency and minimal impact on the environment. Biowaste resources here, for example, food processing wastewaters, domestic wastes and animal wastes, are not only the economic resources for clean energy generation but also are needed to be treated and cleaned. The invention customizes and finds efficient microbes or microorganisms based on an initial content of a biowaste to extract energy and at the same time to treat the biowaste. The selected microorganisms are natural organisms in general. They can be used directly to produce desired clean energy. In addition, the invention can also be used to guide the bioengineering or alternation of the selected natural organisms for better efficiency. The system provides an efficient and sustainable method to generate clean energy at the same time offset the biowaste treatment costs. The invention also aims to reduce the experimental costs and justify the selection microorganisms before they are experimentally tested.

### DESCRIPTION OF DRAWINGS

FIG. 0: A General layout of a MFC in which in the anodic compartment (001) the bacteria (002) can bring about oxidative conversions of organic substances while in the cathodic compartment chemical and microbial reductive processes can occur. 001 is anodic compartment with wastes, 002 is bacteria, 003 is anode, 004 is cathode, 005 is cathodic compartment, 006 is external conductor, 007 is external appliance.

FIG. 1: The overall process of the invention. Step 1, Step 2 and Step 3 are the key procedures for selecting microorganisms and other screening applications in the invention.

FIG. 2: One of the example applications of the invention for recovering hydrogen, electricity and clean water from wastewaters.

FIG. 3: Specifically selected bacteria (306A, 306B) using CASCADE for food processing waste (302) and domestic waste (304), used in a MFC base system (308), to generate electricity for a bulb (410).

FIG. 4: Switching the bacteria (406A, 406B) From FIG. 3 for different initial contents (402,404) used in the same MFC base system (408) might cause no or weak electricity/light generation (410).

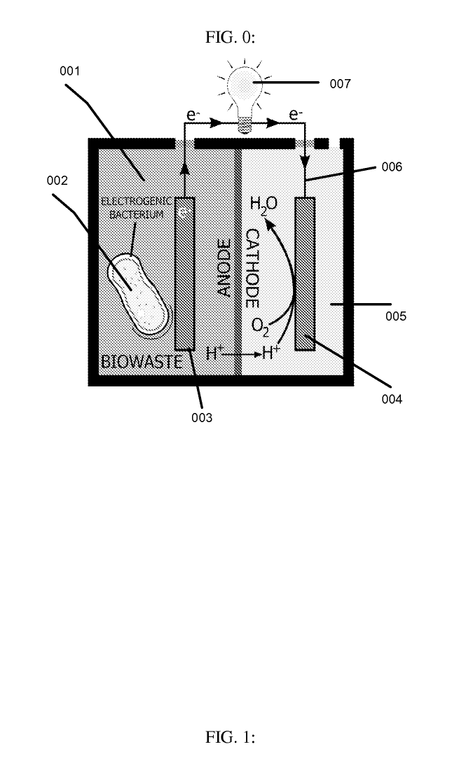

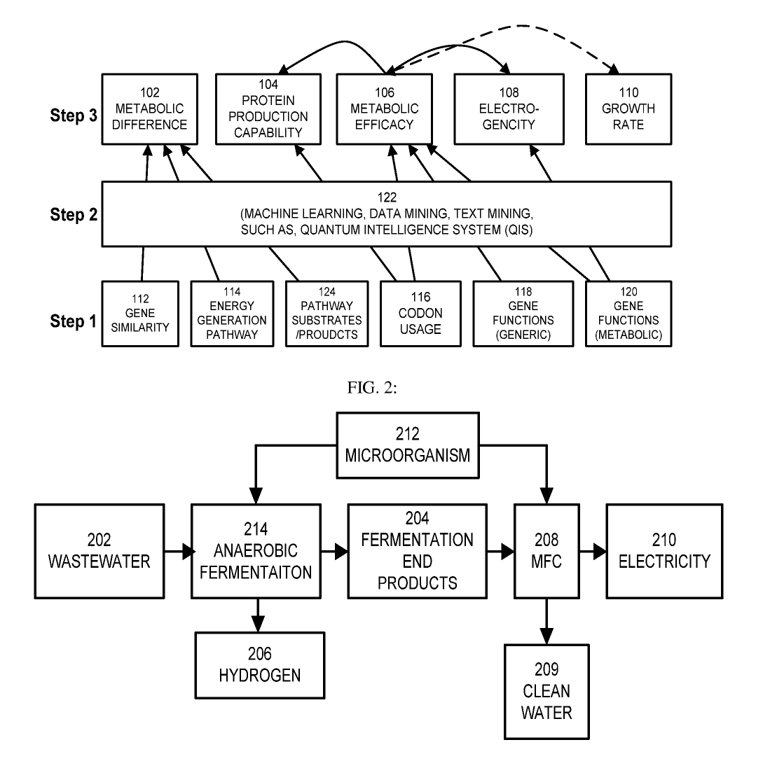

### DETAILED DESCRIPTION OF THE INVENTION

Step 1: Compile a profile: For a given organism, a given content of a biowaste input (202 and 124) and a desired clean energy output (206, 210), compile a profile for that organism, i.e. data or text that best describes the organism with respect to the input, output and its biological system as a whole. For example, data and text that describes a biological system as a whole can be gene similarity among organisms (112), genes' generic functions (118), genes' metabolic functions (120), biological pathways (114) and pathway substrates/products (124) involving energy-generation. This is done for the organisms in various databases such as KEGG, or the organisms metabolically reconstructed directly from genomic sequences, or the organisms in literature with other types of genetic information.

Step 2: Group the organism population. Apply a machine learning, data mining, text mining and pattern recognition method, such as Quantum Intelligence System (QIS) (122) to group the organism population into characteristic groups based on the profiles compiled in Step 1. QIS includes a set of data and text mining techniques integrating small, local and quantum intelligence into a global understanding.

Step 3: Apply a metabolic efficiency measure to match a profile. One or a group of microorganisms are selected based a profile match score. The score is calculated for each organism from a defined metabolic efficiency measure for the organism. A metabolic efficiency measure is a prediction of a desired capability in real life based on an organism's profile. A metabolic efficiency measure depends on the applications, for example,
Average number of genes in metabolic pathways (106, 110)
Unique number of genes in metabolic pathways (106)
Percentage of gene usages in gene function categories (104, 108)
Average codon usage frequencies with respect to a pathway product (104, 106)
Gene similarity (112) and difference along the metabolic pathways with respect to a reference organism (102)
Number of substrates consumed and products produced in the reactions involved in a fermentation process (214) which uses a biowaste input (202) as the feeding substrates (124). The desired products will be hydrogen (206) and fermentation end products (204) which then serve as the input substrates for the subsequent step (208).
Number of substrates consumed and products produced in reactions, which use the fermentation end products (204) mentioned above as the feeding substrates (124), involving in generating the desired clean energy output ( 208,210)
   How Do These Components or Steps Work Together, and How is the Invention Used?

We want to show an example of recovering clean energy from treating wastewaters from food process industries, domestic, animal or meat-packing wastes (202). Using a microorganism or consortia (212), clean hydrogen (206) can be recovered from an anaerobic fermentation process (214) accompanying the wastewater treatment, and the end products from the fermentation process such as acetic acid (acetate), butyric acids (butyrate), propionic acid, ethnol, lactate (204) can be fed into a Microbial Fuel Cell (MFC) process (208) to generate clean electricity (210) and at the same time treat the wastewater to become clean water (209), using the same or different microorganisms (212). The invention can be used to first select the microorganisms to efficiently generate hydrogen and select electrogenic organisms to convert the by-products into electricity.

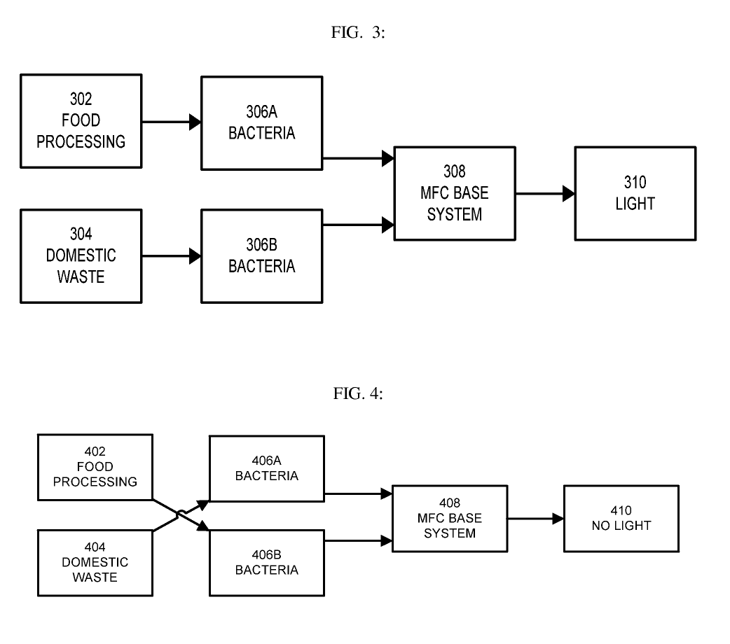

FIG. 3 and FIG. 4 are examples to show one of the application prototyps to illustrate a MFC base system (308, 408) for treating and recovering energy from wastewaters is sensitive to the selection of microorganism with respect to an initial wastewater content. Bacteria (306A, 306B) are selected using CASCADE or other experimental methods are specialized for treating and recovering energy from specific wastewaters, for example, wastewater from a food processing (302, 402) or a domestic wastewater (304, 404). A bacterium (306A) may generate significant electricity from food processing wastewater (302), the same bacterium (406A, 306A) may not work for domestic wastewater (304, 404), and vice versa. The same MFC system is connected to an electric device, such as, a light bulb, to show the electrical current for both treatments. When switching the bacteria for the different wastewaters (402, 404) contents results in no or weaker electricity generated in the bulb (410).

### APPLICATION EXAMPLE 1

The system can be installed on a ship, such as, a military ship or a commercial ship to processing the wastewaters on the ship. It cleans the water and also generates hydrogen, electricity, or methane to be used on the ship.

### APPLICATION EXAMPLE 2

The system can be installed at a sugar plant, a brewery, a winery, a dairy, or beverage plants to process their wastewaters. These wastewaters contain higher sugar, grain, carbohydrates and other organic substances for energy to be extracted using this invention. In U.S. alone, there are about 24,000 such factories which will need wastewater treatments or recycles.

### APPLICATION EXAMPLE 3

The system can be installed on a site of municipal wastewater treatment facilities to clean the water and generate clean energy to cover current expensive aerating process.

### APPLICATION EXAMPLE 4

The system can be installed on a farm for animal waste treatments to generate cleaner energy than the current biogas generation process.

What is claimed is:

1. A method for selecting microorganisms to generate clean energy from biowastes consisting of (a) compiling organisms' profiles by linking the massive genetic and chemical fingerprints in the metabolic and energy-generating biological pathways to the organisms' biological behaviors; (b) grouping the organism population into characteristic groups using a machine learning and pattern recognition system based on the profiles; and (c) selecting one or a group of microorganisms based on profile match scores calculated from a defined metabolic efficiency measure, wherein the metabolic efficiency measure is a prediction of a desired capability in real life based on an organism's profile.

2. The method of claim 1, which is an in silico screening platform, or a knowledge pattern learning and search system.

3. The method of claim 1, wherein said microorganisms consist of bacteria, fungi, archaea, and protists. Microorganisms can be a single species or a mixture of consortia. Microorganisms can be natural or bioengineered and genetic-altered organisms.

4. The method of claim 1, wherein said clean energy is clean, renewable and alternative energy which has the maximum efficiency and minimal impact on the environment, wherein said clean energy comprises hydrogen, electricity, ethanol, methane, biogas and solar energy.

5. The method of claim 1, wherein said biowastes comprise food and drink processing wastewaters, domestic wastewaters, animal or meat-packing wastes, metal wastes, nuclear wastes, by-products of industrial processes such as DDGS (distillers dry grain and solubles) from ethanol production.

6. The method of claim 1, wherein in step (a) within said metabolic and energy-generating biological pathways comprise metabolism, genetic information processing, environmental information processing, and cellular processes pathways:
Metabolism pathways consist of carbohydrate metabolism, energy metabolism, lipid metabolism, nucleotide metabolism, amino acid metabolism, metabolism of other amino acids, glycan biosynthesis and metabolism, biosynthesis of polyketides and nonribosomal peptides, metabolism of cofactors and vitamins, biosynthesis of secondary metabolites, xenobiotics biodegradation and metabolism, and metabolism of enzyme families.
Genetic information processing pathways consist of transcription, translation, aminoacyl-trna biosynthesis, folding, sorting and degradation, replication and repair pathways.
Environmental information processing pathways consist of membrane transport, signaling molecules and interaction pathways, and phosphatidylinositol signaling system,
Cellular processes pathways consist of cell motility, cell growth and death, and cell communication pathways.

7. The method of claim 1, wherein step (a) within said the massive genetic and chemical fingerprints of the organisms in the metabolic and energy-generating biological pathways comprise gene similarity scores along the metabolic pathways among organisms, gene usages in the metabolic pathways, percentage of gene usages in general function categories, codon usages, and distribution of gene usages in metabolic function categories.

8. The method of claim 1, wherein step (a) within said organisms' biological behaviors include abilities to utilize or digest certain substrates, to undergo aerobic or anaerobic fermentation, to produce hydrogen (hydrogenic), electricity (electrogenic), methane (methanogenic), or other desired products.

9. The method of claim 1, wherein step (a) within said organisms' profiles are the data or text describing the organisms with respects to its biological system (as said massive genetic and chemical fingerprints) that link to the organism's biological behaviors:
Data or text describing the organisms with respects to its biological system as a whole consist of genomic information, codon usages, gene distributions along biological (metabolic and regulatory) pathways and networks, gene distributions in function categories, gene similarity among organisms, genes' generic functions, genes' metabolic functions, biological pathways involving energy-generation, and pathway substrates/products involving energy-generation,
Organisms' profiles are collected from various databases such as KEGG (Kyoto Encyclopedia of Genes and Genomes), or the organisms metabolically reconstructed directly from genomic sequences, or the organisms in literature with other types of genetic information,
Organisms' profiles can be data or text that best describes the organism with respect to the input substrates, output products and its biological system while the said linked biological behaviors are the ability to digest the input substrates and to produce the output products given the contents of a biowaste input and a desired clean energy output are provided.

10. The method of claim 9, wherein said organisms are selected based on the content of said biowaste input and said desired clean energy output by first linking massive genetic and chemical fingerprints in the metabolic and energy-generating biological pathways, then applying a machine learning and pattern recognition system to assess an organism's metabolic capability to digest a required organic matter and generate clean energy.

11. The method of claim 1, wherein step (b) within said machine learning and pattern recognition system uses machine learning, data mining, text mining and pattern recognition method to group the organism population into characteristic groups based on their profiles. Machine learning and pattern recognition system include supervised machine learning, unsupervised machine learning methods and pattern recognition methods for profiling, grouping and clustering organisms including neural networks, decision trees, radial basis functions, logistic regression, K-means clustering, Kohonen maps, hierarchical clustering, etc.

12. The method of claim 1, wherein step (c) within said metabolic efficiency measures are defined depending on applications, for example, average or unique number of genes in metabolic pathways and gene function categories, average codon usage frequencies with respect to a pathway product and gene similarity along the metabolic pathways with respect to a reference organism. Metabolic efficiency measure can be number of substrates consumed and products produced in the reactions involved in a fermentation process which uses a biowaste input as the feeding substrates, and the desired products will be hydrogen and fermentation end products, such as acetic acid (acetate), butyric acids (butyrate), propionic acid, ethnol, lactate, which then serve as the input substrates for the subsequent step.

13. The method of claim 12, wherein said metabolic efficiency measure can be number of substrates consumed and products produced in reactions, which use the said fermentation end products as the feeding substrates, involving in generating the desired clean energy output.

14. The method of claim 1, wherein step (c) within said profile match scores are calculated for each organism from said defined metabolic efficiency measure to see how well an organism's profile match the various said metabolic efficiency measures. Profile match scores are set higher if said organism's profile matches better with the said corresponding metabolic efficiency measure, and vice versa.

15. The method of claim 1, wherein step (c) within said one or a group of microorganisms are selected while the said profile match scores are above certain thresholds.

16. The method of claim 1, wherein step (c) within said desired capability of organisms in real life are part of the said organisms' biological behaviors in step (a), for example, the abilities to utilize or digest certain substrates, to produce desired products such as hydrogen, electricity, methane, etc.

17. The method of claim 1, wherein the selected said microorganisms can be used
to produce desired and useful recombinant proteins. Recombinant proteins are antibodies, peptides such as spider silk and human acetylcholinesterase isoforms
to produce a desired pathway product, for example, high-value compounds important in pharmaceuticals and fine chemicals such as isoprenoids, succinate
to explore novel properties such as glycosylation that is necessary for producing antibody
to perform specific biological experiments based on research interest and need

18. The method of claim 2, wherein said knowledge pattern learning and search system can be used in different applications, such as human pathogen screening based on pathogens' specific properties contributing to their pathogenic nature to human; small molecules selection for drug efficacy and toxicity, e.g. anti-cancer, anti-HIV; gene and biomarker screening for detecting biothreat agent infection, e.g. human tularemia disease; DNA aptamer selection to counter biological agents, such as detection and identification of biological threat agents;

19. The method of claim 2, wherein said knowledge pattern learning and search system can be used in broader applications in non-scientific fields, such as election a population of people for marketing a product; election a population of companies for investing; selection information for business opportunities.

20. A method for selecting a microorganism or consortia to generate clean hydrogen, and clean electricity from wastewaters from food process industries, domestic, animal or meat-packing wastes consisting of: (a) compiling organisms' profiles by linking the massive genetic and chemical fingerprints in the metabolic and energy-generating biological pathways to the organisms' ability to undergo anaerobic fermentation by utilizing or digesting an initial said wastewater content and produce hydrogen from the said process, to utilize or digest the end products from the said fermentation process such as acetic acid (acetate), butyric acids (butyrate), propionic acid, ethnol, lactate in a Microbial Fuel Cell (MFC) system to generate clean electricity; (b) grouping the organism population into characteristic groups using a machine learning and pattern recognition system based on the profiles compiled in part (a); (c) selecting one or a group of microorganisms based on profile match scores calculated from the defined metabolic efficiency measures, wherein the said metabolic efficiency measures are number of substrates consumed and products produced in the reactions involved in said fermentation process which uses said biowaste input as the feeding substrates, and the said desired products are hydrogen and fermentation end products which then serve as the input substrates for the subsequent step; and (d) selecting one or a group of microorganisms based on profile match scores calculated from the defined metabolic efficiency measures, wherein the said metabolic efficiency measures are number of substrates consumed and products produced in reactions, which use the said fermentation end products as the feeding substrates, involving in generating the desired clean electricity output in a Microbial Fuel Cell (MFC) system. Microbial Fuel Cell (MFC) system are devices that generate current by using bacteria as the catalysts to oxidize organic or inorganic substances.
